(19) United States
(12) Patent Application Publication
(10) Pub. No.: US 2017/0242543 A1
(43) Pub. Date: Aug. 24, 2017

(54) DISPLAY DEVICE

(71) Applicant: InnoLux Corporation, Miao-Li County (TW)

(72) Inventors: Meng-Hsueh CHAN, Miao-Li County (TW); Wen-Yang CHIEN, Miao-Li County (TW); Nien-En LIU, Miao-Li County (TW); Chia-Chin LIN, Miao-Li County (TW); Ping-Hsu CHENG, Miao-Li County (TW)

(21) Appl. No.: 15/441,866

(22) Filed: Feb. 24, 2017

(30) Foreign Application Priority Data
Feb. 24, 2016 (TW) 105105524

(51) Int. Cl. G06F 3/041; G06F 3/044

(52) U.S. Cl. CPC G06F 3/0418; G06F 3/044; G06F 2203/04107; G06F 2203/04105

(57) ABSTRACT

A display device includes a display panel, a first substrate, a first pressure electrode layer, a second pressure electrode layer and a compression layer. The display panel has a display area and a peripheral area located besides the display area. The first substrate is disposed opposite to the display panel. The first pressure electrode layer is disposed at one side of the first substrate facing the display panel and corresponding to the peripheral area. The second pressure electrode layer is disposed at one side of the display panel facing the first substrate. The compression layer is disposed between the first pressure electrode layer and the second pressure electrode layer.

### CROSS REFERENCE TO RELATED APPLICATIONS

This Non-provisional application claims priority under 35 U.S.C. §119(a) on Patent Application No(s). 105105524 filed in Taiwan, Republic of China on Feb. 24, 2016, the entire contents of which are hereby incorporated by reference.

### BACKGROUND

Technical Field

The present disclosure relates to a display device and, in particular, to a display device with a pressure sensing function.

Related Art

As the progress of technology, various kinds of information apparatuses are invented such as the mobile phone, tablet, UMPC, GPS, etc. Except for the general input devices such as the keyboard and mouse, the touch input device is one of the popular input devices. In practice, the touch device can provide a user-friendly and intuitive input interface, so that the users of different ages can easily operate the touch device by a finger or a stylus.

The 2D multi-touch technology is one of the popular touch technologies, and it can precisely determine the position pressed by finger according to the capacitance changes, thereby generating the corresponding control function. Besides, the capacitance pressure sensing technology is use to sense the pressing in the Z-axis, which is perpendicular to the display surface, thereby generating the corresponding control function. However, the structural cooperation of the capacitance pressure sensing technology and the 2D touch sensing electrode is limited.

### SUMMARY

The present disclosure provides a display device capable of sensing the pressure force. The display device of the disclosure can generate a control function corresponding to the pressing force and is more convenience in operation.

To achieve the above, the disclosure discloses a display device, which includes a display panel, a first substrate, a first pressure electrode layer, a second pressure electrode layer, and a compression layer. The display panel has a display area and a peripheral area located besides the display area. The first substrate is disposed opposite to the display panel. The first pressure electrode layer is disposed at one side of the first substrate facing the display panel and corresponding to the peripheral area. The second pressure electrode layer is disposed at one side of the display panel facing the first substrate. The compression layer is disposed between the first pressure electrode layer and the second pressure electrode layer.

### BRIEF DESCRIPTION OF THE DRAWINGS

The embodiments will become more fully understood from the detailed description and accompanying drawings, which are given for illustration only, and thus are not limitative of the disclosure, and wherein:

FIG. 1 is a schematic diagram showing a display device according to an embodiment of the disclosure;

FIGS. 2A to 2I are schematic diagrams showing different aspects of the display devices according to the embodiment of the disclosure;

FIGS. 3A to 3C and 4A to 4D are schematic diagrams showing the patterns of various aspects of the first pressure electrode layer, the second pressure electrode layer and the third pressure electrode layer of the disclosure; and

FIGS. 5A to 5H are schematic diagrams showing various aspects of the pressure sensing elements of the first, second and third pressure electrode layers of the disclosure.

### DETAILED DESCRIPTION OF THE DISCLOSURE

The embodiments of the disclosure will be apparent from the following detailed description, which proceeds with reference to the accompanying drawings, wherein the same references relate to the same elements. Moreover, the drawings of all implementation are schematic, and they do not mean the actual size and proportion. The terms of direction recited in the disclosure, for example up, down, left, right, front, or rear, only define the directions according to the accompanying drawings for the convenience of explanation but not for limitation. The names of elements and the wording recited in the disclosure all have ordinary meanings in the art unless otherwise stated. Therefore, a person skilled in the art can unambiguously understand their meanings.

It should be noted that the expression “a layer overlying another layer”, “a layer is disposed above another layer”, “a layer is disposed on another layer”, “a layer is disposed over another layer”, and “a layer is formed on another layer” may indicate that the layer is in direct contact with the other layer, or that the layer is not in direct contact with the other layer, there being one or more intermediate layers disposed between the layer and the other layer.

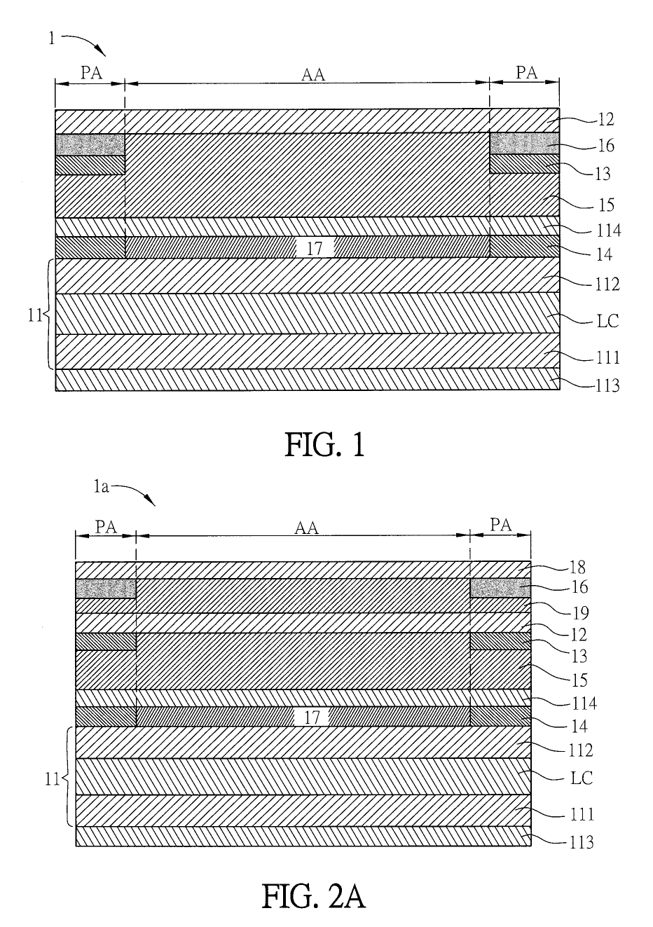

FIG. 1 is a schematic diagram showing a display device 1 according to an embodiment of the disclosure. As shown in FIG. 1, the display device 1 is, for example but not limited to, a mobile phone, tablet, UMPC, wearable device, or other display devices, and this disclosure is not limited. Besides, the display device 1 of the embodiment has a 2D multi-touch function, so it is also named as a touch display device.

The display device 1 includes a display panel 11, a first substrate 12 and a pressure sensing structure, which includes a first pressure electrode layer 13, a second pressure electrode layer 14, and a compression layer 15. Moreover, the display device 1 further includes a shielding layer 16 and a touch electrode 17.

The display panel 11 can be a liquid crystal display (LCD) panel, an organic light-emitting diode (OLED) panel, a light-emitting diode (LED) panel, or a quantum dot (QD) panel, and this disclosure is not limited. Further, the display panel 11 can be a flat display panel or 3D-curve display panel. Meanwhile, the shape of the display panel 11 can be rectangular or non-rectangular. The non-rectangular shape is generally called as free shape and includes circle, ellipse, polygon or non-regular. The display panel 11 has a display area AA and a peripheral area PA disposed besides the display area AA. The light can pass through the display area AA to display images, and the peripheral area PA is used to configure the peripheral components such as the driving devices, switching devices, traces, wires, circuit boards, or other electronic devices. In this embodiment, the peripheral area PA is disposed besides the display area AA.

In this embodiment, the display panel 11 is a LCD panel, which includes a first transparent substrate 111, a second transparent substrate 112 and a display intermediate layer LC. The first transparent substrate 111 and the second transparent substrate 112 can be a rigid or flexible substrate. The first transparent substrate 111 and the second transparent substrate 112 are disposed opposite to each other, and the display intermediate layer LC is disposed between the first transparent substrate 111 and the second transparent substrate 112. Herein, the first transparent substrate 111 is a TFT substrate, the second transparent substrate 112 is a CF substrate, and the display intermediate layer LC is a liquid crystal layer. Besides, the display device 1 further includes a backlight module (not shown) disposed at one side of the first transparent substrate 111 away from the second transparent substrate 112. The light emitted from the backlight module passes through the display panel 11 so as to enable the display area AA of the display panel 11 to display images. The backlight module includes a light guiding plate, a reflective plate, a plurality of optical sheets, and a back plate. The backlight module is well known to those skilled persons, so the detailed descriptions of the relations and functions of the backlight module and the display panel 11 are omitted.

In addition, the display device 1 further includes a first polarizer 113 and a second polarizer 114. The first polarizer 113 (the lower polarizer) is disposed at one side of the first transparent substrate 111 away from the second transparent substrate 112, and the second polarizer 114 (the upper polarizer) is disposed at one side of the second transparent substrate 112 away from the first transparent substrate 111. Herein, the first polarizer 113 is attached to the lower surface of the first transparent substrate 111, the second polarizer 114 is disposed between the display panel 11 and the first substrate 12. The touch electrode 17 is disposed between the display panel 11 and the first substrate 12. The second polarizer 114 is disposed on the touch electrode 17, so that the touch electrode 17 is located between the second polarizer 114 and the second transparent substrate 112. In other embodiments, the touch electrode 17 can be disposed inside the display panel 11.

The touch electrode 17 is electrically connected to the second pressure electrode layer 14. The touch electrode 17 is disposed corresponding to the display area AA, so that the display device 1 becomes a TOD (touch on display) touch display device. In this case, the touch electrode 17 includes a driving electrode and a sensing electrode (2D touch control), and a plurality of traces are configured adjacent to the touch electrode 17 and corresponding to the peripheral area PA. These traces connect to the touch electrode 17 corresponding to the display area AA for transmitting or receiving the signals of the touch electrode 17, or for grounding. In this embodiment, the second pressure electrode layer 14 is co-used as the plurality of traces corresponding to the peripheral area PA.

The first pressure electrode layer 13 is disposed at one side of the first substrate 12 facing the display panel 11 and corresponding to the peripheral area PA. The second pressure electrode layer 14 is disposed at one side of the display panel 11 facing the first substrate 12. The compression layer 15 is disposed between the first pressure electrode layer 13 and the second pressure electrode layer 14. In this embodiment, the second pressure electrode layer 14 is disposed corresponding to the peripheral area PA, and the compression layer 15 is disposed on a surface of the second polarizer 114 facing the first substrate 12 and corresponding to the display area AA and the peripheral area PA. The shielding layer 16 is disposed between the first substrate 12 and the first pressure electrode layer 13 and corresponding to the peripheral area PA. In this case, the shielding layer 16 is located on a surface of the first substrate 12 facing the display panel 11 and corresponding to the peripheral area PA. The first pressure electrode layer 13 is also disposed corresponding to the peripheral area PA. The compression layer 15 is disposed between the first pressure electrode layer 13 and the second pressure electrode layer 14. In this embodiment, the shielding layer 16 covering the peripheral area PA is for the vision consideration. That is, the pressure sensing function of the disclosure is not affected in the absence of the shielding layer 16.

The first substrate 12 can be a light-permeable protective glass or plastic plate (e.g. PC, PMMA, or PET). In this embodiment, the first substrate 12 is a protective glass for preventing the external moisture or dusts from entering the display device 1. The shielding layer 16 can cover the driving components (switches), traces, wires, circuit boards, or other electronic components disposed corresponding to the peripheral area PA. Accordingly, when the user views the display device 1 from the top side of the first substrate 12, the shielding layer 16 and the first pressure electrode layer 13 are overlapped so as to cover the first pressure electrode layer 13 (and the second pressure electrode layer 14) and the components disposed corresponding to the peripheral area PA. The shielding layer 16 can be made of ink, photoresist, their combinations, or a decoration film. In practice, the shielding layer 16 can be made of a black ink, a white ink, a BM (black matrix) photoresist, or a combination of the black ink and the BM photoresist, and this disclosure is not limited.

The first pressure electrode layer 13 and the second pressure electrode layer 14 are made of conductive materials such as metal, alloy or transparent conductive materials. The suitable metal material can be, for example but not limited to, Mo, Al, Ag or Cu. The suitable transparent conductive material can be, for example but not limited to, ITO (indium-tin oxide), IZO (indium-zinc oxide), AZO (aluminum-zinc oxide), CTO, SnO₂, GZO, IGZO, IZTO, or ZnO (zinc oxide). Besides, the first pressure electrode layer 13 and the second pressure electrode layer 14 may also be added with a conductive polymer such as PEDOT:PSS, carbon nanotube (CNT), graphene, silver nanowire, or metal mesh, and this disclosure is not limited. When the second pressure electrode layer 14 is disposed corresponding to the display area AA and the peripheral area PA, it should be made of transparent conductive materials, so that the light can pass through the second pressure electrode layer 14. When the second pressure electrode layer 14 is disposed corresponding to the peripheral area PA, it can be made of the transparent, opaque or partial transparent material, and this disclosure is not limited. Besides, the compression layer 15 can include an optically clear adhesive (OCA), a liquid optically clear adhesive (LOCA), an optically clear resin (OCR), a super view resin (SVR), or a silicon gel, and this disclosure is not limited.

As viewing from the top of the display panel 11 (or from the top of the first substrate 12), the first pressure electrode layer 13 is substantially disposed corresponding to the periphery located besides the touch electrode 17. In this embodiment, the traces connecting to the touch electrode 17 include the traces for transmitting touch signals and a plurality of grounding lines, and the second pressure electrode layer 14 includes at least one grounding line. In other words, the traces connecting to the touch electrode 17 are disposed corresponding to the peripheral area PA and include grounding lines, so that the grounding lines connecting to the touch electrode 17 can be used as the reference electrode of the display device 1 (the second pressure electrode layer 14). In other embodiments, the second pressure electrode layer 14 can be used as the traces for connecting the touch electrode 17. In other words, it is also possible to use the traces configured for transmitting the touch signals as the reference electrode of the pressure sensing structure (the second pressure electrode layer 14). This can be achieved by inserting a blanking time in the transmitted touch signals, and this disclosure is not limited.

In the display device 1, when the upper surface of the first substrate 12 is not pressed (not apply a force in the Z direction), the first pressure electrode layer 13, the second pressure electrode layer 14 (the grounding lines), and the compression layer 15 disposed between the first pressure electrode layer 13 and the second pressure electrode layer 14 can form a capacitance. In this case, a pressure detecting circuit (not shown) of the display device 1 provides a first voltage (non-zero voltage) to the first pressure electrode layer 13 and a second voltage (e.g. a ground voltage) to the second pressure electrode layer 14, so that the first pressure electrode layer 13 and the second pressure electrode layer 14 will have a voltage difference. Thus, an initial capacitance value is existed between the first pressure electrode layer 13 and the second pressure electrode layer 14.

When a finger presses the first substrate 12 along the Z direction, the first pressure electrode layer 13 and the compression layer 15 are deformed, so that the distance between the first pressure electrode layer 13 and the second pressure electrode layer 14 becomes smaller. Accordingly, the capacitance value between the first pressure electrode layer 13 and the second pressure electrode layer 14 is changed from the initial capacitance value to a pressed capacitance value. Then, the pressure detecting circuit of the display device 1 can determine the value of the pressing force depending on the variation between the initial capacitance value and the pressed capacitance value. In general, if the pressing force is larger, the variation is more obvious. The variation can also be named as a pressure sensing signal. Besides, the pressure detecting circuit can generate a control function corresponding to the pressing force. For example, a plane touch can be referred to a control function of previewing the application menu, and a force touch can be referred to a control function of opening the application menu. These functions can make the operation more quickly and conveniently. Herein, the pressure detecting circuit for determining the pressure sensing signal can be formed in an isolated IC or integrated in the control driving IC of the display panel 11, and this disclosure is not limited.

The display device 1 of this embodiment has a pressure sensing structure disposed at one side of the display panel 11 facing the first substrate 12, and the first pressure electrode layer 13 of the pressure sensing structure is disposed corresponding to the peripheral area PA of the display panel 11. This configuration can prevent the electric field shielding or interference of the pressure sensing structure (the first pressure electrode layer 13), thereby avoiding the bad sensitivity of the touch electrode 17. Moreover, since the position of the pressure sensing structure is closer to the user, the capacitance variation caused by the external pressure will become more obvious. This feature can improve the sensitivity of the pressure sensing or make the control operation more precise.

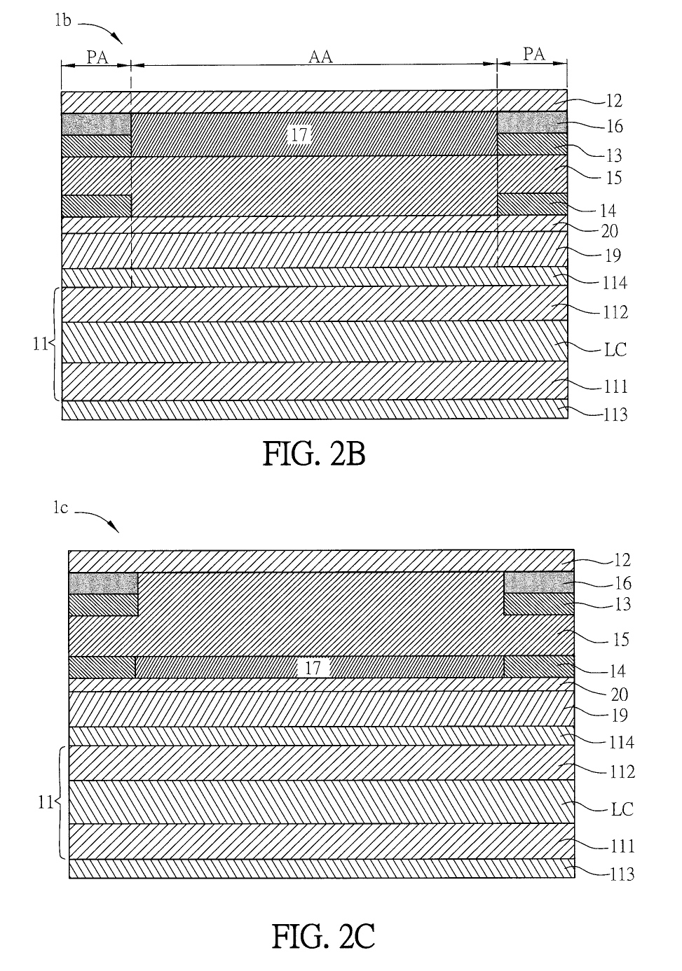

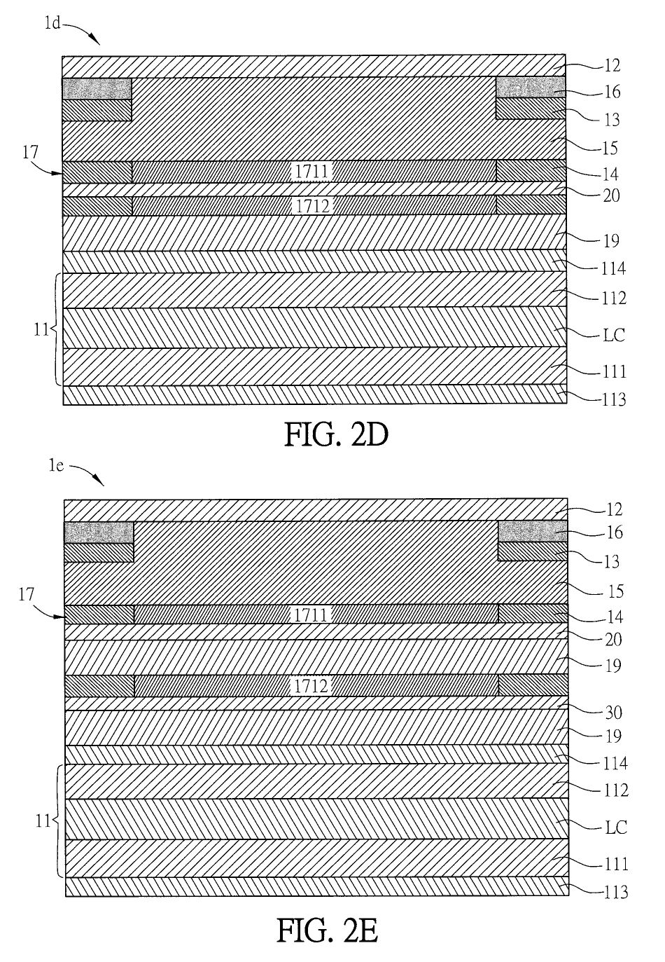

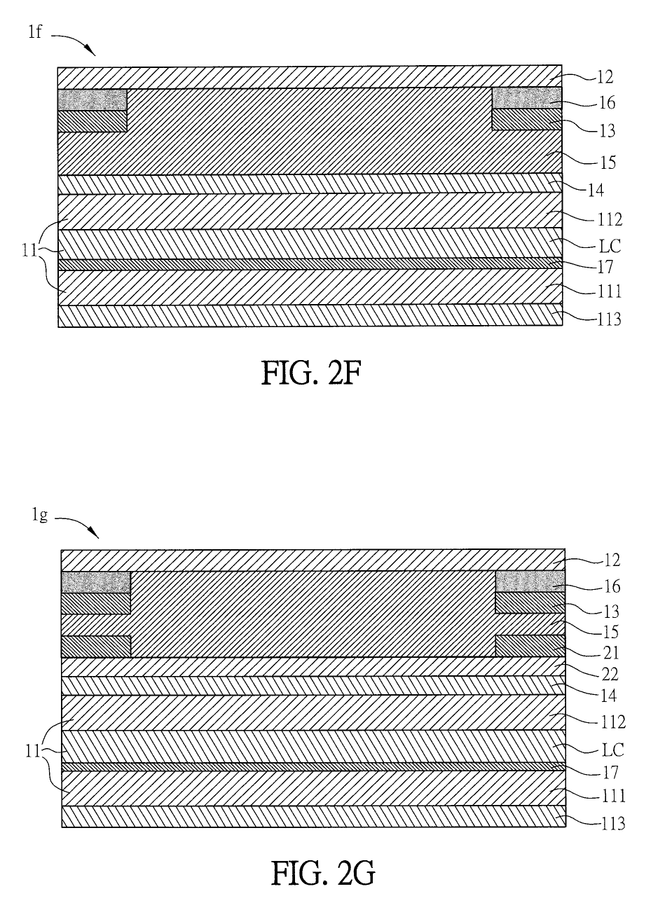

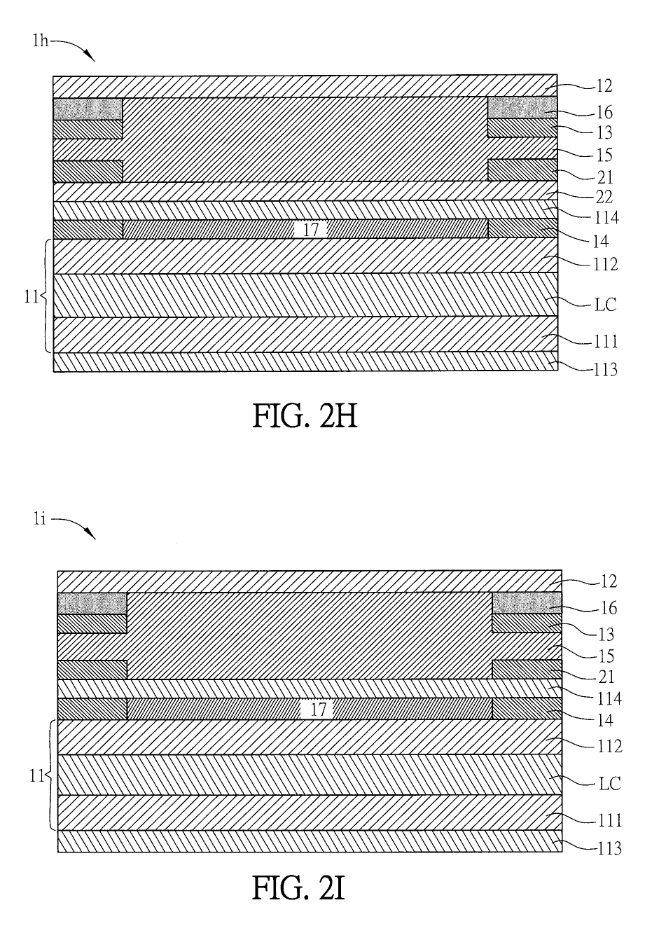

FIGS. 2A to 2I are schematic diagrams showing different aspects of the display devices 1a˜1i according to the embodiment of the disclosure.

As shown in FIG. 2A, the display device 1a also includes a display panel 11, a first substrate 12, a first pressure electrode layer 13, a second pressure electrode layer 14, a compression layer 15, a shielding layer 16 and a touch electrode 17 as the above-mentioned display device 1. Moreover, the display device 1a further includes a cover plate 18 disposed at one side of the first substrate 12 away from the display panel 11. In this aspect, the first substrate 12 can be a glass substrate, a plastic substrate or a film. The cover plate 18 is the protective component of the display device 1a, such as a cover glass or a plastic plate. The cover plate 18 is attached to the first substrate 12 by an adhesive layer 19, such as OCA. In addition, the shielding layer 16 of this aspect is disposed on a surface of the cover plate 18 facing the display panel 11 instead of the surface of the first substrate 12 facing the display panel 11, but it is also disposed corresponding to the peripheral area PA. The other technical features of the display device 1a can be referred to the same components of the display device 1, so the detailed descriptions thereof will be omitted.

As shown in FIG. 2B, different from the display device 1, the touch electrode 17 of the display device 1b is disposed on a surface of the first substrate 12 facing the display panel 11. The touch electrode 17 is disposed corresponding to the display area AA and electrically connected to the first pressure electrode layer 13. The shielding layer 16 is disposed corresponding to the peripheral area PA and located between the first substrate 12 and the first pressure electrode layer 13. The first pressure electrode layer 13 includes at least one grounding line. In this aspect, at least one of the grounding lines connecting to the touch electrode 17 functions as the first pressure electrode layer 13. In other embodiments, the traces for transmitting the signals of the touch electrode 17 can function as the first pressure electrode layer 13, and this disclosure is not limited.

The display device 1b further includes a second substrate 20, which is disposed between the first substrate 12 and the display panel 11. The second pressure electrode layer 14 is a conductive film, which is disposed corresponding to the peripheral area PA and located on a surface of the second substrate 20 facing the first substrate 12. In addition, the second substrate 20 is attached to the second polarizer 114 by an adhesive layer 19. The second substrate 20 can be a glass substrate or a film, and this disclosure is not limited. In this aspect, the display device 1b is a WIS (windows integrated sensor) touch display device. The other technical features of the display device 1b can be referred to the same components of the display device 1, so the detailed descriptions thereof will be omitted.

As shown in FIG. 2C, different from the display device 1b, the touch electrode 17 of the display device 1c is disposed on a surface of the second substrate 20 facing the first substrate 12 instead of the surface of the first substrate 12 facing the display panel 11, so that the touch electrode 17 is disposed between the second substrate 20 and the compression layer 15. Herein, the second substrate 20 is a glass substrate or a film, and this disclosure is not limited. The touch electrode 17 is electrically connected to the second pressure electrode layer 14. In this aspect, at least one grounding line connected to the touch electrode 17 functions as the second pressure electrode layer 14. In other embodiments, the trace for transmitting the touch signal of the touch electrode 17 can function as the second pressure electrode layer 14. In this case, the trace functions as the reference electrode by inserting a blanking time in the transmitted touch signals, and this disclosure is not limited. The other technical features of the display device 1c can be referred to the same components of the display device 1b, so the detailed descriptions thereof will be omitted.

As shown in FIG. 2D, different from the display device 1c, the touch electrode 17 of the display device 1d includes a first touch electrode 1711 and a second touch electrode 1712. The first touch electrode 1711 and the traces thereof are disposed on a surface of the second substrate 20 facing the first substrate 12, and the second touch electrode 1712 and the traces thereof are disposed on a surface of the second substrate 20 facing the display panel 11. Accordingly, the second substrate 20 is disposed between the first touch electrode 1711 and the second touch electrode 1712. The second substrate 20 can be a film or a glass. In addition, the second touch electrode 1712 is attached to the surface of the second polarizer 114 facing the second substrate 20 by an adhesive layer 19. The other technical features of the display device 1d can be referred to the same components of the display device 1c, so the detailed descriptions thereof will be omitted.

As shown in FIG. 2E, different from the display device 1d, the first touch electrode 1711 (and the second pressure electrode layer 14) of the display device 1e is disposed on a surface of the second substrate 20 facing the first substrate 12, and the display device 1e further includes a third substrate 30 disposed between the second substrate 20 and the display panel 11. The second touch electrode 1712 and the trace thereof (not shown) are disposed on a surface of the third substrate 30 facing the second substrate 20. Each of the second substrate 20 and the third substrate 30 can be a film or a glass. In addition, the second touch electrode 1712 and the trace thereof are attached to the second substrate 20 by an adhesive layer 19, and the third substrate 30 is attached to the second polarizer 114 by another adhesive layer 19. The other technical features of the display device 1e can be referred to the same components of the display device 1d, so the detailed descriptions thereof will be omitted.

As shown in FIG. 2F, different from the display device 1 of FIG. 1, the touch electrode 17 of the display device 1f is disposed in the display panel 11, and is located on a surface of the first transparent substrate 111 facing the second transparent substrate 112. In addition, the second polarizer 114 (not shown) is disposed on a surface of the second transparent substrate 112 facing the first substrate 12, and includes a conductive film (not shown). The second pressure electrode layer 14 is this conductive film. In other words, the display device 1f is a TID (touch in display) touch display device, and the second polarizer 114 with the conductive film is used as the second pressure electrode layer 14, which means the second pressure electrode layer 14 is the second polarizer 114. In other embodiments, the second polarizer 114 can be doped with conductive particles so as to form a conductive film with high sheet resistance (10⁸Ω˜10¹²Ω). The other technical features of the display device 1f can be referred to the same components of the display device 1, so the detailed descriptions thereof will be omitted. Besides, the driving control modes of the display devices 1a˜1f can also be referred to that of the display device 1, so the detailed descriptions thereof will be omitted.

As shown in FIG. 2G, different from the display device 1f of FIG. 2F, the display device 1g further includes a third pressure electrode layer 21 and an insulation layer 22. The third pressure electrode layer 21 is disposed on the insulation layer 22 and located corresponding to the first pressure electrode layer 13. That is, the third pressure electrode layer 21 is disposed corresponding to the peripheral area PA. The compression layer 15 is disposed between the first pressure electrode layer 13 and the third pressure electrode layer 21. In addition, the insulation layer 22 is disposed between the compression layer 15 and the second pressure electrode layer 14 (the second polarizer). Since the second polarizer 114 has a conductive film, the configuration of the insulation layer 22 can prevent the short circuit between the third pressure electrode layer 21 and the second polarizer 114 (the second pressure electrode layer 14). In other words, the third pressure electrode layer 21 is disposed corresponding to the peripheral area PA of the display panel 11, the compression layer 15 is disposed between the first pressure electrode layer 13 and the third pressure electrode layer 21, and the insulation layer 22 is disposed between the third pressure electrode layer 21 and the second pressure electrode layer 14 (the second polarizer 114). The third pressure electrode layer 21 can be made of the same material as the first pressure electrode layer 13 and the second pressure electrode layer 14, and this disclosure is not limited. The other technical features of the display device 1g can be referred to the same components of the display device 1f, so the detailed descriptions thereof will be omitted.

To be noted, the insulation layer 22 and the third pressure electrode layer 21 can also be applied to any of the above-mentioned display devices 1a˜1e by the same way as described in the display device 1g.

The pressure sensing structure of the display device 1g includes three pressure electrode layers (the first pressure electrode layer 13, the second pressure electrode layer 14 and the third pressure electrode layer 21), so it has two driving control modes.

The first driving control mode of the display device 1g is stated as follow. When the display device 1g is not pressed, the first pressure electrode layer 13, the compression layer 15 and the third pressure electrode layer 21 can form a capacitance with an initial capacitance value. In this case, the first pressure electrode layer 13 is applied a first voltage. The third pressure electrode layer 21 is a reference electrode, and a reference voltage is applied to the third pressure electrode layer 21. The first voltage is different from the reference voltage. When the display device 1g is pressed, the first pressure electrode layer 13 and the compression layer 15 are deformed by the pressing force, so that the distance between the first pressure electrode layer 13 and the third pressure electrode layer 21 becomes smaller. Thus, the capacitance value between the first pressure electrode layer 13 and the third pressure electrode layer 21 is changed from the initial capacitance value to a pressed capacitance value. Then, the pressure detecting circuit of the display device 1g can determine the value of the pressing force depending on the variation between the initial capacitance value and the pressed capacitance value. Besides, the pressure detecting circuit can generate a control function corresponding to the pressing force.

The second driving control mode of the display device 1g is stated as follow. When the display device 1g is not pressed, the first pressure electrode layer 13, the compression layer 15 and the second pressure electrode layer 14 can form a first capacitance with a first initial capacitance value, and the third pressure electrode layer 21, the insulation layer 22 and the second pressure electrode layer 14 can form a second capacitance with a second initial capacitance value. When the display device 1g is pressed, the first pressure electrode layer 13 and the compression layer 15 are deformed by the pressing force, so that the distance between the first pressure electrode layer 13 and the second pressure electrode layer 14 becomes smaller. Thus, the capacitance value between the first pressure electrode layer 13 and the second pressure electrode layer 14 is changed from the first initial capacitance value to a first pressed capacitance value. In addition, since the third pressure electrode layer 21 is disposed inside the display device 1g, the distance between the third pressure electrode layer 21 and the second pressure electrode layer 14 is kept the same, so the second initial capacitance value is not changed. Accordingly, the pressure detecting circuit of the display device 1g can obtain a capacitance difference of the second initial capacitance value, and the variation of the first initial capacitance value and the first pressed capacitance value, and then determine the value of the pressing force depending on the obtained capacitance difference. Besides, the pressure detecting circuit can generate a control function corresponding to the pressing force. In this case, the common factors, such as the error caused by the deformation of the materials, can be removed so as to make the pressure detection of the display device 1g more precisely.

Accordingly, the display device 1g of this embodiment has a pressure sensing structure including the first pressure electrode layer 13, the second pressure electrode layer 14, the compression layer 15 and the third pressure electrode layer 21 for sensing the pressing force and determining the value of the pressing force. Besides, the pressure detecting circuit can generate a control function corresponding to the pressing force. This configuration can prevent the electric field shielding or interference of the pressure sensing structure, thereby avoiding the bad sensitivity of the touch electrode 17. Moreover, since the position of the pressure sensing structure is closer to the user, the capacitance variation caused by the external pressure will become more obvious. This feature can improve the sensitivity of the pressure sensing or make the control operation more precise.

As shown in FIG. 2H, different from the display device 1g of FIG. 2G, the touch electrode 17 of the display device 1h further is disposed between the second transparent substrate 112 and the second polarizer 114 instead of being disposed on the surface of the first transparent substrate 111 facing the second transparent substrate 112. In addition, the patterned grounding lines connected to the touch electrode 17 function as a reference electrode of the pressure sensing structure (the second pressure electrode layer 14). The other technical features and driving control modes of the display device 1h can be referred to the description of the display device 1g, so the detailed descriptions thereof will be omitted.

As shown in FIG. 2I, different from the display device 1h of FIG. 2H, the display device 1h is not configured with the insulation layer 22, so the second polarizer 114 is disposed between the touch electrode 17 and the compression layer 15. In this case, the second polarizer 114 is not conductive. The other technical features and driving control modes of the display device 1i can be referred to the description of the display device 1h, so the detailed descriptions thereof will be omitted.

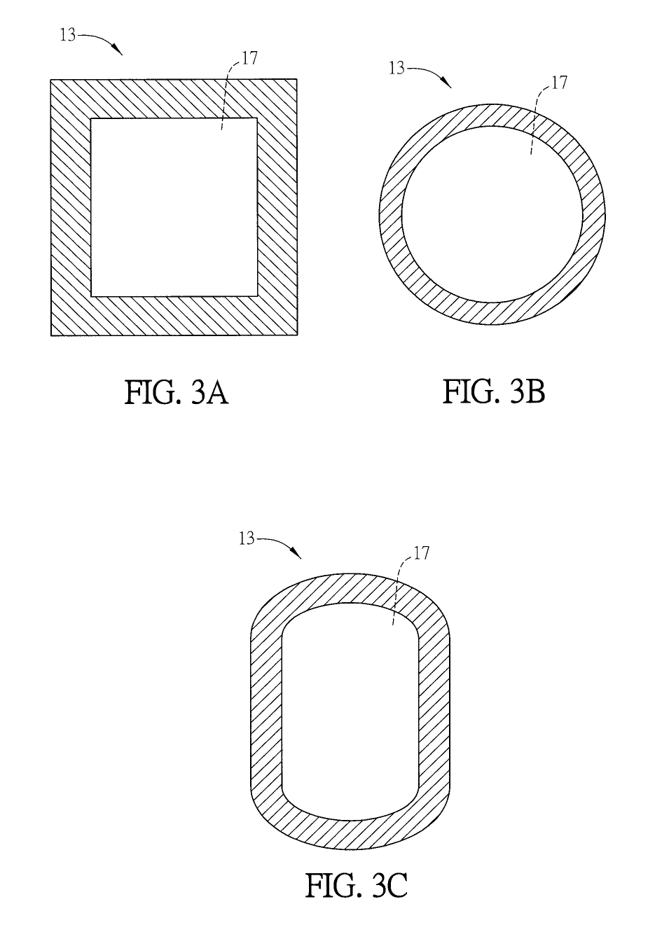

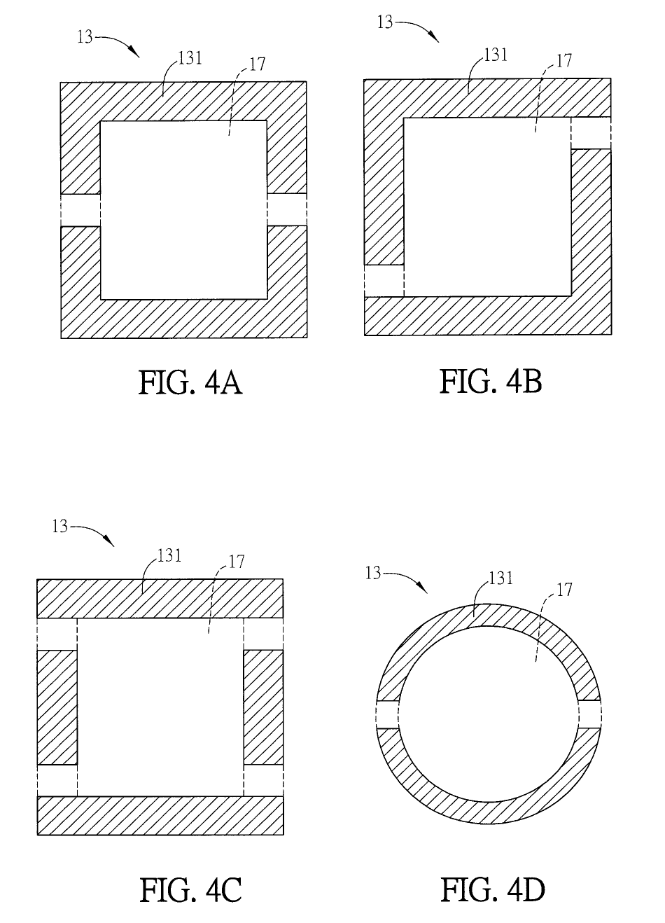

FIGS. 3A to 4D are schematic diagrams showing the patterns of various aspects of the first pressure electrode layer 13, the second pressure electrode layer 14, and the third pressure electrode layer 21.

As viewing from the top of the first substrate 12, the first pressure electrode layer 13 is disposed corresponding to the periphery of the touch electrode 17 (or the display area), and the first pressure electrode layer 13, the second pressure electrode layer 14 and the third pressure electrode layer 21 can form consequent closed patterns. Taking the first pressure electrode layer 13 as an example, as shown in FIGS. 3A to 3C, it can form a closed pattern with a shape of, for example, a polygon (e.g. a triangle, a square (FIG. 3A), a pentagon, etc.), a circle (FIG. 3B), an ellipse (FIG. 3C), or any other closed pattern or their combinations. This disclosure is not limited. Herein, the aspects of FIGS. 3B and 3C can be applied to a wearable device for example.

In addition, the first pressure electrode layer 13, the second pressure electrode layer 14 and the third pressure electrode layer 21 may also include a plurality of pressure sensing sections, which form a discontinuous open pattern. For example, the first pressure electrode layer 13 includes a plurality of pressure sensing sections 131. As shown in FIGS. 4A to 4D, the shape of each pressure sensing section 131 can be a U shape (FIG. 4A), an L shape or a reversed L shape (FIG. 4B), a C shape or a reversed C shape, an arc (FIG. 4D), a bar (FIG. 4C), or any other suitable shape, or their combinations, and this disclosure is not limited.

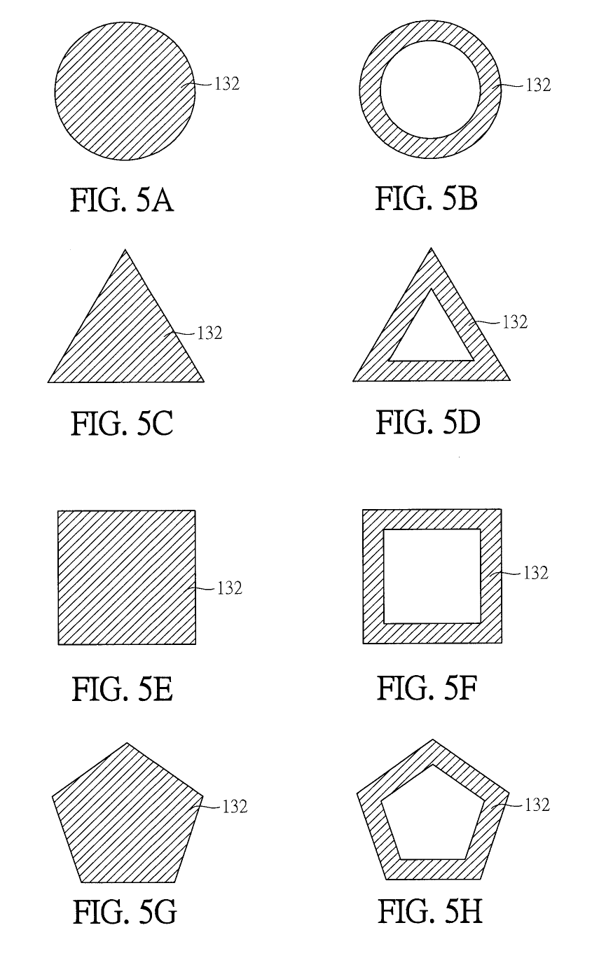

FIGS. 5A to 5H are schematic diagrams showing various aspects of the pressure sensing elements of the first pressure electrode layer 13, the second pressure electrode layer 14, and the third pressure electrode layer 21 of the disclosure.

Moreover, the first pressure electrode layer 13, the second pressure electrode layer 14 and the third pressure electrode layer 21 may include a plurality of pressure sensing element. For example, the first pressure electrode layer 13 includes a plurality of pressure sensing elements 132. As shown in FIGS. 5A to 5H, the shape of each pressure sensing element 132 can be a circle (FIGS. 5A and 5B), a polygon (FIGS. 5C to 5H), or their combinations. In this embodiment, the circle can be a solid circle or a hollow circle, and the polygon can also be a solid polygon or a hollow polygon. This disclosure is not limited. Besides, multiple pressure sensing elements 132 can be arranged as the configurations of the above-mentioned pressure sensing sections. In addition, when the first pressure electrode layer 13 is divided into a plurality of pressure sensing elements 132, each pressure sensing element 132 can connect to a signal line for roughly determining the pressing position on the X-Y plane.

To sum up, in the display device of the disclosure, the first pressure electrode layer is disposed at one side of the first substrate facing the display panel and corresponding to the peripheral area, and the second pressure electrode layer is disposed at one side of the display panel facing the first substrate. The compression layer is disposed between the first pressure electrode layer and the second pressure electrode layer. Accordingly, the display device can generate a control function corresponding to the pressing force, so the operation becomes more convenience.

The disclosure has described several embodiments and the technical features described in those embodiments can be picked, selected, and mixed to form another embodiment. For example, the technical features described in one embodiment can also applied to another embodiment.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel having a display area and a peripheral area located besides the display area;
a first substrate disposed opposite to the display panel;
a first pressure electrode layer disposed at one side of the first substrate facing the display panel and corresponding to the peripheral area;
a second pressure electrode layer disposed at one side of the display panel facing the first substrate; and
a compression layer disposed between the first pressure electrode layer and the second pressure electrode layer.

2. The display device of claim 1, wherein the compression layer is disposed corresponding to the display area and the peripheral area.

3. The display device of claim 1, wherein the compression layer includes an optically clear adhesive (OCA), a liquid optically clear adhesive (LOCA), an optically clear resin (OCR), a super view resin (SVR), or a silicon gel.

4. The display device of claim 1, further comprising:
a shielding layer disposed between the first substrate and the first pressure electrode layer and corresponding to the peripheral area.

5. The display device of claim 1, further comprising:
a cover plate disposed at one side of the first substrate away from the display panel; and
a shielding layer disposed at one side of the cover plate facing the display panel and corresponding to the peripheral area.

6. The display device of claim 1, further comprising:
a touch electrode disposed between the display panel and the first substrate, or located in the display panel.

7. The display device of claim 6, wherein the touch electrode is electrically connected to the second pressure electrode layer, the touch electrode is disposed corresponding to the display area, and the second pressure electrode layer is disposed corresponding to the peripheral area.

8. The display device of claim 7, wherein the second pressure electrode layer comprises a grounding line.

9. The display device of claim 6, wherein the touch electrode is electrically connected to the first pressure electrode layer, the touch electrode is disposed corresponding to the display area.

10. The display device of claim 9, wherein the first pressure electrode layer comprises a grounding line.

11. The display device of claim 9, wherein the touch electrode is disposed on a surface of the first substrate facing the display panel.

12. The display device of claim 6, further comprising a polarizer disposed between the display panel and the first substrate, wherein the touch electrode is disposed between the polarizer and the display panel.

13. The display device of claim 6, further comprising:
a second substrate disposed between the first substrate and the display panel,
wherein the second pressure electrode layer is disposed on a surface of the second substrate facing the first substrate.

14. The display device of claim 13, further comprising:
a second substrate disposed between the first substrate and the display panel, wherein the touch electrode is disposed on the surface of the second substrate facing the first substrate, and the touch electrode is electrically connected to the second pressure electrode layer.

15. The display device of claim 6, further comprising:
a second substrate disposed between the first substrate and the display panel, wherein the touch electrode comprises a first touch electrode and a second touch electrode, and the second substrate is disposed between the first touch electrode and the second touch electrode.

16. The display device of claim 6, further comprising:
a second substrate and a third substrate, wherein the second substrate is disposed between the first substrate and the third substrate, and the third substrate is disposed between the second substrate and the display panel;
wherein the touch electrode comprises a first touch electrode and a second touch electrode, the first touch electrode is disposed on a surface of the second substrate facing the first substrate, and the second touch electrode is disposed on a surface of the third substrate facing the second substrate.

17. The display device of claim 1, further comprising:
a third pressure electrode layer disposed between the first pressure electrode layer and the second pressure electrode layer, and corresponding to the peripheral area.

18. The display device of claim 1, wherein the first pressure electrode layer forms a continuous closed pattern, and the closed pattern is a polygon, a circle, or an ellipse.

19. The display device of claim 1, wherein the first pressure electrode layer comprises a plurality of pressure sensing sections.

20. The display device of claim 1, wherein the first pressure electrode layer comprises a plurality of pressure sensing elements, and a shape of each of the pressure sensing elements is a polygon, a circle, or an ellipse.
